(19) United States
(12) Patent Application Publication
(10) Pub. No.: US 2024/0343401 A1
(43) Pub. Date: Oct. 17, 2024

(54) CORONA DISCHARGE MANAGEMENT FOR HYDROGEN FUEL CELL-POWERED AIRCRAFT

(71) Applicant: ZEROAVIA LIMITED, Kemble (GB)

(72) Inventors: Valery Miftakhov, San Carlos, CA (US); Bob L. Mackey, San Jose, CA (US)

(73) Assignee: ZEROAVIA LIMITED, Kemble (GB)

(21) Appl. No.: 18/682,834

(22) PCT Filed: Aug. 27, 2021
(86) PCT No.: PCT/GB2021/052243

§ 371 Date: Feb. 9, 2024

(51) Int. Cl. B64D 27/355; H01M 8/04111; H01M 8/10

(52) U.S. Cl. CPC B64D 27/355; H01M 8/04111; H01M 2008/1095; H01M 2250/20

(57) ABSTRACT

An aircraft includes a chamber (1), a processor, a memory, and a compressor system (12b) in fluid communication with the chamber. The compressor system (12b) configured to selectively pressurize the chamber (1). The chamber supports a fuel cell (26), a motor, and/or electrical components that electrically communicate with the fuel cell (26) and the motor to power the aircraft. The memory includes instructions stored thereon, which when executed by the processor, cause the aircraft to receive an altitude value of the aircraft, and selectively pressurize the chamber using the compressor system based on the received altitude value to reduce corona discharge in the chamber.

### FIELD

The present disclosure relates generally to hydrogen fuel cell-powered aircraft and, more specifically, to systems and methods for corona discharge management in hydrogen fuel cell-powered aircraft.

### BACKGROUND

While the fundamental theory and application of using hydrogen fuel cells to power electrically-driven aircraft is proven and established, there remain many challenges with respect to the specific integration of hydrogen fuel cell technology in aircraft design. For example, just like existing conventionally powered aircraft designs, the mechanical, electronic, fluidic, and thermal systems of hydrogen fuel cell-powered aircraft need to be properly engineered to provide appropriate power, efficiency, safety, and physical characteristics. For example, when such hydrogen fuel cells are used on planes at high altitudes, for example, at 40 to 50 thousand feet, with a corresponding decrease in ambient atmospheric pressure, a phenomenon known as corona discharge occurs, that is, the air near the high voltage point of the terminals becomes ionized. As a consequence of this ionization, a loss in power and a loss in the efficiency of transmission takes place. Accordingly, systems and methods for managing corona discharge are needed. Conventionally, this would require a dramatic increase in insulation thickness, creepage distances, etc.

### SUMMARY

Terms including “approximately,” “about,” “substantially,” and the like, as utilized herein, are meant to encompass variations and/or tolerances up to and including plus or minus 10 percent. Any or all of the aspects described herein, to the extent consistent, may be used in conjunction with any or all of the other aspects described herein.

Provided in accordance with aspects of the present disclosure, an aircraft includes a processor, a memory, and a chamber a compressor system configured to regulate a pressure and a flow of air to the fuel cell, the compressor system in fluid communication with the chamber. The compressor system is configured to selectively pressurize the chamber. The chamber supports at least one of a fuel cell, a motor, or electrical components that electrically communicate with the fuel cell and the motor to power the aircraft. The memory includes instructions stored thereon, which when executed by the processor cause the aircraft to receive an altitude value of the aircraft, and selectively pressurize the chamber using the compressor system based on the received altitude value to reduce corona discharge in the chamber.

In an aspect of the present disclosure, the altitude value may be received by a sensor. The sensor may include an altimeter, a GPS, and/or a telemetry device.

In another aspect of the present disclosure, the instructions, when executed by the processor, may further cause the aircraft to receive a signal indicating a pressure of the chamber and selectively pressurize the chamber using the compressor system based on the signal indicating the pressure of the chamber.

In yet another aspect of the present disclosure, the chamber may further support an electrical system of the aircraft.

In a further aspect of the present disclosure, a nacelle of the aircraft includes the chamber.

In yet a further aspect of the present disclosure, the predetermined threshold value may be about 10,000 feet above sea level.

In an aspect of the present disclosure, the instructions, when executed by the processor, may cause the aircraft to select the predetermined threshold value based upon a predetermined unpressurized operation parameter of the electrical system and perform an engine restart of the electrical system at the predetermined threshold value.

In another aspect of the present disclosure, the instructions, when executed by the processor, may further cause the aircraft to provide as an input to a machine-learning algorithm the determined altitude value and a flight profile, a weather, and/or a flight path, predict a pressurization value by the machine-learning algorithm; and selectively pressurize the chamber using the compressor system based on the predicted pressurization value to reduce corona discharge in the chamber.

In yet another aspect of the present disclosure, the aircraft may further include a second sensor which is configured to sense the pressurization value of the chamber. The instructions, when executed by the processor, cause the aircraft to compare the sensed pressurization value to the predetermined threshold value to a predetermined pressurization value, determine, based on the sensed pressurization value of the chamber, if the altitude value is above the predetermined pressurization value, and selectively pressurize the chamber using the compressor system based on the predetermined pressurization value to reduce corona discharge in the chamber.

Provided in accordance with aspects of the present disclosure, a fuel cell-powered electric engine system includes a chamber which is configured to house an electrical system of the fuel cell-powered electric engine system, the electrical system including a fuel cell, a compressor system in fluid communication with the fuel cell and the chamber, a processor, and a memory. The memory includes instructions stored thereon, which when executed by the processor, cause the system to receive an altitude value of the fuel cell-powered electric engine system, and selectively pressurize the chamber using the compressor system based on the received altitude value to reduce corona discharge in the chamber.

In a further aspect of the present disclosure, the altitude value may be received by a sensor. The sensor may include an altimeter, a GPS, and/or a telemetry device.

In yet a further aspect of the present disclosure, the instructions, when executed by the processor, may further cause the system to receive a signal indicating a pressure of the chamber and selectively pressurize the chamber using the compressor system based on the signal indicating the pressure of the chamber.

In an aspect of the present disclosure, the chamber may further support the electrical system of the fuel cell-powered electric engine.

In another aspect of the present disclosure, a nacelle of an airplane includes the chamber.

In yet another aspect of the present disclosure, the predetermined threshold value may be about 10,000 feet above sea level.

In a further aspect of the present disclosure, the instructions, when executed by the processor, cause the system to select the predetermined threshold value based upon a predetermined unpressurized operation parameter of the electrical system and perform an engine restart of the integrated hydrogen-electric engine system at the predetermined threshold value.

In yet a further aspect of the present disclosure, the instructions, when executed by the processor, may further cause the system to provide as an input to a machine-learning algorithm the determined altitude value and a flight profile, weather, and/or a flight path, predict a pressurization value by the machine-learning algorithm, and selectively pressurize the chamber using the compressor system based on the predicted pressurization value to reduce corona discharge in the chamber.

In an aspect of the present disclosure, wherein the fuel cell-powered electric engine may further include a second sensor which is configured to sense the pressurization value of the chamber. The instructions, when executed by the processor may further cause the system to compare the sensed pressurization value to the predetermined threshold value, determine, based on the sensed pressurization value of the chamber if the altitude value is above a predetermined pressurization value, and selectively pressurize the chamber using the compressor system based on the predetermined pressurization value to reduce corona discharge in the chamber.

Provided in accordance with aspects of the present disclosure, a computer-implemented method for corona discharge management includes receiving an altitude value of an aircraft including a fuel cell-powered electric engine system, and selectively pressurizing a chamber using a compressor system of the aircraft, based on the received altitude value to reduce corona discharge in the chamber. The chamber supports a fuel cell, a motor, and electrical components that electrically communicate with the fuel cell and the motor to power the aircraft.

In an aspect of the present disclosure, the method may further include receiving a signal indicating a pressure value of the chamber and selectively pressurizing the chamber using the compressor system based on the signal indicating the pressure of the chamber.

In yet another aspect of the present disclosure, the method may further include determining if the altitude value is above a predetermined threshold value and selectively pressurizing a chamber using a compressor system of the aircraft, based on the determination.

In yet another aspect of the present disclosure, the method may further include sensing a pressure, a descent, and/or a corona discharge from a sensor and adjusting an operating voltage of a fuel cell stack based on the sensed pressure.

### BRIEF DESCRIPTION OF DRAWINGS

The above and other aspects and features of the present disclosure will become more apparent in view of the following detailed description when taken in conjunction with the accompanying drawings wherein like reference numerals identify similar or identical elements.

FIG. 1 is a side view of a hydrogen fuel cell-powered aircraft in accordance with the present disclosure;

FIG. 2 is a schematic illustration of a hydrogen fuel cell-electric engine system of the aircraft of FIG. 1;

FIG. 3 is a schematic view of a fuel cell of the integrated hydrogen-electric engine system of FIG. 1; and

FIG. 4 is a block diagram of a controller configured for use with integrated hydrogen-electric engine system of FIG. 2;

FIG. 5 is a block diagram of a computer-controlled method for corona discharge management using the system of FIG. 2;

FIG. 6 is a flow diagram of a machine learning algorithm of the computer-controlled method for corona discharge management using the system of FIG. 2; and

FIG. 7 is a diagram of layers of a neural network of FIG. 6 in accordance with aspects of the disclosure.

### DETAILED DESCRIPTION

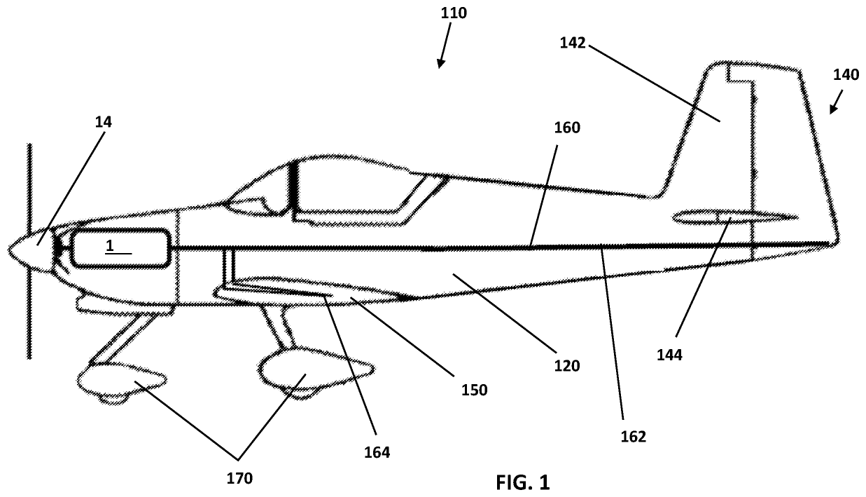

Referring to FIG. 1, a hydrogen fuel cell-powered aircraft 110 is illustrated and described as a turboprop aircraft although other suitable aircraft configurations are also contemplated. Aircraft 110 generally includes a fuselage 120, a propulsor 14 (e.g., a propeller) disposed at a forward end of fuselage 120, a tail 140 disposed at a rear end of fuselage 120 and including a vertical stabilizer 142 and a pair of horizontal stabilizers 144 (only one of which is shown) extending outwardly from either side of tail 1140, a pair of wings 150 (only one of which is shown) extending outwardly from either side of fuselage 120, an exhaust system 160 including a fuselage portion 162 and/or a wing portion 164, a pair of wheel assemblies 170, and an integrated hydrogen-electric engine system 1.

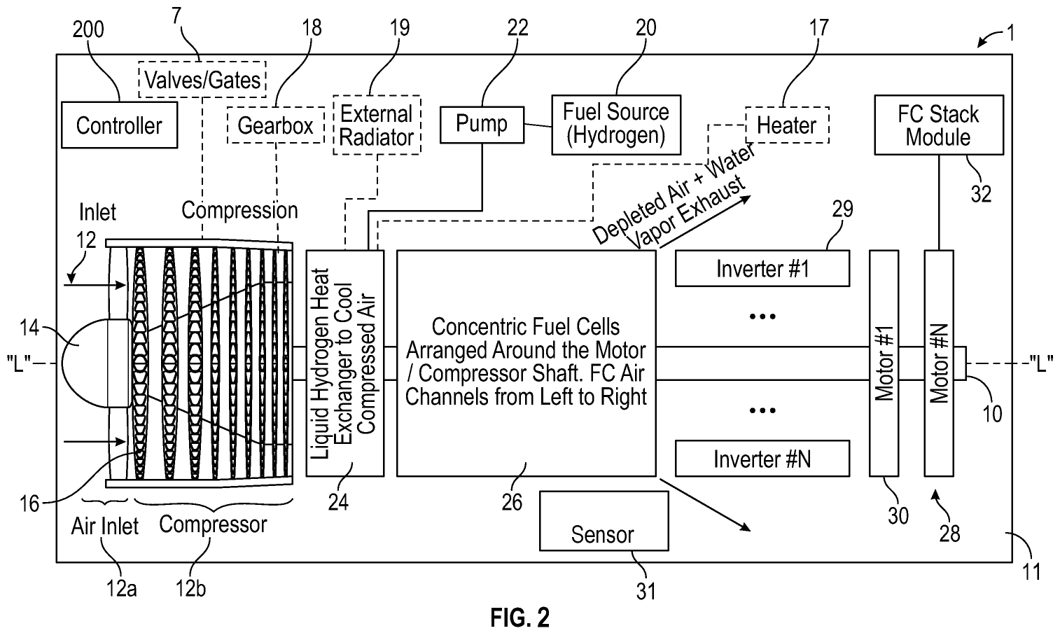

FIG. 2 illustrates integrated hydrogen-electric engine system 1 of aircraft 110, that can be utilized, for example, in a turboprop or turbofan system, to provide a streamlined, light weight, power dense and efficient system. In general, integrated hydrogen-electric engine system 1 includes an elongated shaft 10 that defines a longitudinal axis “L” and extends through the entire powertrain of integrated hydrogen-electric engine system 1 to function as a common shaft for the various components of the powertrain. Elongated shaft 10 supports propulsor 14 (e.g., a fan or propeller) and a multi-stage air compressor system 12, a pump 22 in fluid communication with a fuel source (e.g., hydrogen), a heat exchanger 24 in fluid communication with air compressor system 12, a fuel cell stack 26 in fluid communication with heat exchanger 24, and a motor assembly 28 disposed in electrical communication with fuel cell stack 26.

Air compressor system 12 of integrated hydrogen-electric engine system 1 includes an air inlet portion 12a at a distal end thereof and a compressor portion 12b that is disposed proximally of air inlet portion 12a for uninterrupted, axial delivery of air flow in the proximal direction. Compressor portion 12b supports a plurality of longitudinally spaced-apart rotatable compressor wheels 16 (e.g., multi-stage) that rotate in response to rotation of elongated shaft 10 for compressing air received through air inlet portion 12a for pushing the compressed air to a fuel cell stack 26 for conversion to electrical energy. As can be appreciated, the number of compressor wheels/stages 16 and/or diameter, longitudinal spacing, and/or configuration thereof can be modified as desired to change the amount of air supply, and the higher the power, the bigger the propulsor 14. These compressor wheels 16 can be implemented as axial or centrifugal compressor stages. Further, the compressor can have one or more bypass valves and/or wastegates 7 to regulate the pressure and flow of the air that enters the downstream fuel cell, as well as to manage the cold air supply to any auxiliary heat exchangers in the system.

Compressor 12 can optionally be mechanically coupled to elongated shaft 10 via a gearbox 18 to change (increase and/or decrease) compressor turbine rotations per minute (RPM) and to change the air flow to fuel cell stack 26. For instance, gearbox 18 can be configured to enable the air flow, or portions thereof, to be exhausted for controlling a rate of air flow through the fuel cell stack 26, and thus, the output power.

Integrated hydrogen-electric engine system 1 further includes a gas management system such as a heat exchanger 24 disposed concentrically about elongated shaft 10 and configured to control thermal and/or humidity characteristics of the compressed air from air compressor system 12 for conditioning the compressed air before entering fuel cell stack 26. Integrated hydrogen-electric engine system 1 further also includes a fuel source 20 of fuel cryogenic (e.g., liquid hydrogen—LH2, or cold hydrogen gas) that is operatively coupled to heat exchanger 24 via a pump 22 configured to pump the fuel from fuel source 20 to heat exchanger 24 for conditioning compressed air. In particular, the fuel, while in the heat exchanger 24, becomes gasified because of heating (e.g., liquid hydrogen converts to gas) to take the heat out of the system. The hydrogen gas then gets heated in the heat exchanger 24 to a working temperature of the fuel cell 26 which also takes heat out of the compressed air, which results in a control of flow through the heat exchanger 24. In embodiments, a heater 17 can be coupled to or included with heat exchanger 24 to increase heat as necessary, for instance, when running under a low power regime. Additionally, and/or alternatively, motor assembly 28 can be coupled to heat exchanger 24 for looping in the cooling/heating loops from motor assembly 28, as necessary. Such heating/cooling control can be managed, for instance, via controller 200 of integrated hydrogen-electric engine system 1. In embodiments, fuel source 20 can be disposed in fluid communication with motor assembly 28 or any other suitable component to facilitate cooling of such components.

Pump 22 can also be coaxially supported on elongated shaft 10 for actuation thereof in response to rotation of elongated shaft 10. Heat exchanger 24 is configured to cool the compressed air received from air compressor system 12 with the assistance of the pumped liquid hydrogen.

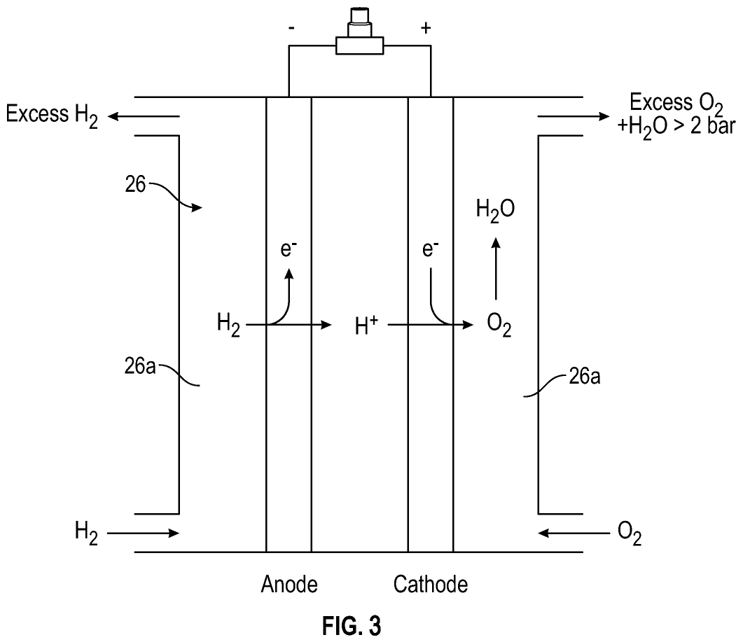

With reference also to FIG. 3, integrated hydrogen-electric engine system 1 further includes an energy core in the form of a fuel cell stack 26, which may be circular, and is also coaxially supported on elongated shaft 10 (e.g., concentric) such that air channels 26a of fuel cell stack 26 may be oriented in parallel relation with elongated shaft 10 (e.g., horizontally, or left-to-right). Fuel cell stack 26 may be in the form of a proton-exchange membrane fuel cell (PEMFC). The fuel cells of the fuel cell stack 26 are configured to convert chemical energy liberated during the electrochemical reaction of hydrogen and oxygen to electrical energy (e.g., direct current). Depleted air and water vapor are exhausted from fuel cell stack 26. The electrical energy generated from fuel cell stack 26 is then transmitted to motor assembly 28, which is also coaxially/concentrically supported on elongated shaft 10. In aspects, integrated hydrogen-electric engine system 1 may include any number of external radiators 19 (FIG. 2) for facilitating air flow and adding, for instance, additional cooling. Notably, fuel cell stack 26 can include liquid cooled and/or air-cooled cell types that so that cooling loads are integrated into heat exchanger 24 for reducing total amount of external radiators needed in the system.

Motor assembly 28 of integrated hydrogen-electric engine system 1 includes a plurality of inverters 29 configured to convert the direct current to alternating current for actuating one or more of a plurality of motors 30 in electrical communication with the inverters 29. The plurality of motors 30 are configured to drive (e.g., rotate) the elongated shaft 10 in response to the electrical energy received from fuel cell stack 26 for operating the components on the elongated shaft 10 as elongated shaft 10 rotates.

In aspects, one or more of the inverters 29 may be disposed between motors 30 (e.g., a pair of motors) to form a motor subassembly, although any suitable arrangement of motors 30 and inverters 29 may be provided. The motor assembly 28 can include any number of motor subassemblies supported on elongated shaft 10 for redundancy and/or safety. Motor assembly 28 can include any number of fuel cell stack modules 32 configured to match the power of the motors 30 and the inverters 29 of the subassemblies. In this regard, for example, during service, the modules 32 can be swapped in/out. Each module 32 can provide any power, such as 400 kw or any other suitable amount of power, such that when stacked together (e.g., 4 or 5 modules), total power can be about 2 Megawatts on the elongated shaft 10. In embodiments, motors 30 and inverters 29 can be coupled together and positioned to share the same thermal interface so a motor casing of the motors 30 is also an inverter heat sink so only a single cooling loop goes through motor assembly 28 for cooling the inverters 29 and the motors 30 at the same time. This reduces the number of cooling loops and therefore the complexity of the system.

Integrated hydrogen-electric engine system 1 further includes a controller 200 (e.g., a full authority digital engine (or electronics) control (e.g., a FADEC) for controlling the various aspects of the integrated hydrogen-electric engine system 1 and/or other components of aircraft system. For instance, controller 200 can be configured to manage a flow of liquid hydrogen, manage coolant liquids from the motor assembly 28, manage, for example, any dependent auxiliary heater for the liquid hydrogen, manage rates of hydrogen going into fuel cell stack 26, manage rates of heated/cooled compressed air, and/or various flows and/or power of integrated hydrogen-electric engine system 1. The algorithm for managing these thermal management components can be designed to ensure the most efficient use of the various cooling and heating capacities of the respective gases and liquids to maximize the efficiency of the system and minimize the volume and weight of same. For example, the cooling capacity of liquid hydrogen or cool hydrogen gas (post-gasification) can be effectively used to cool the hot compressor discharge air to ensure the correct temperature range in the fuel cell inlet. Further, the cooling liquid from the motor-inverter cooling loop could be integrated into the master heat exchanger and provide the additional heat required to gasify hydrogen and heat it to the working fuel cell temperature.

The transmission of power may result in high voltage points along the terminals and/or transmission lines of the integrated hydrogen-electric engine system 1. As an airplane increases in altitude there is a decrease in atmospheric pressure, which causes the air to become more easily ionized, and a phenomenon known as corona discharge occurs. To solve this problem the integrated hydrogen-electric engine system 1 includes a chamber 11 (e.g., a housing such as the nacelle of the aircraft) that defines a selectively pressurizeable cavity therein. The chamber 11 may house one or more of the fuel cells 26, the inverters 29, motors 30 and/or any other power distribution and/or electronics (e.g., the entire electrical system of integrated hydrogen-electric engine system 1, or portions thereof, may be supported within the chamber 11). The compressor system 12 is in fluid communication with the chamber 11 by a tube or other fluid conduit. The compressor system 12 is further configured to selectively pressurize the chamber 11 to maintain a predetermined pressurization value. The predetermined pressurization value may include atmospheric pressure at about sea level, and/or a specific altitude such as 10,000 feet above sea level. For example, the compressor system 12 may be configured to keep pressure within the cavity substantially at the value prevailing at sea level. By maintaining pressure at the predetermined pressurization value, corona discharge may be prevented and/or reduced, and the transmission of high voltage signals may be affected at high altitudes without loss of efficiency due to voltage breakdown or leakage. The chamber may further include a sensor 31 configured to sense a signal indicative of the pressure maintained in the cavity of the chamber 11.

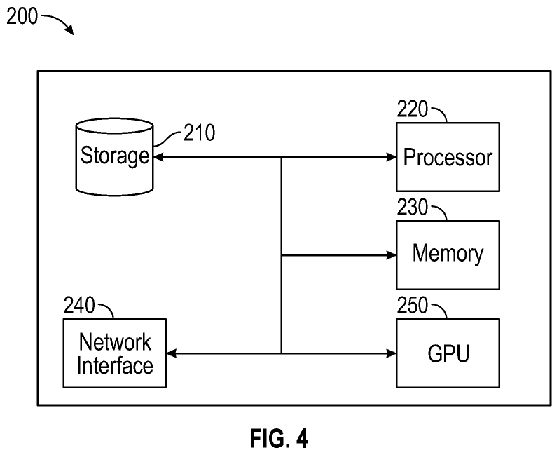

FIG. 4 illustrates that controller 200 includes a processor 220 connected to a computer-readable storage medium or a memory 230. The computer-readable storage medium or memory 230 may be a volatile type of memory, e.g., RAM, or a non-volatile type of memory, e.g., flash media, disk media, etc. In various aspects of the disclosure, the processor 220 may be another type of processor such as, without limitation, a digital signal processor, a microprocessor, an ASIC, a graphics processing unit (GPU), a field-programmable gate array (FPGA), or a central processing unit (CPU). In certain aspects of the disclosure, network inference may also be accomplished in systems that have weights implemented as memristors, chemically, or other inference calculations, as opposed to processors.

In aspects of the disclosure, the memory 230 can be random access memory, read-only memory, magnetic disk memory, solid-state memory, optical disc memory, and/or another type of memory. In some aspects of the disclosure, the memory 230 can be separate from the controller 200 and can communicate with the processor 220 through communication buses of a circuit board and/or through communication cables such as serial ATA cables or other types of cables. The memory 230 includes computer-readable instructions that are executable by the processor 220 to operate the controller 200. In other aspects of the disclosure, the controller 200 may include a network interface 240 to communicate with other computers or to a server. A storage device 210 may be used for storing data.

The disclosed method may run on the controller 200 or on a user device, including, for example, on a mobile device, an IoT device, or a server system. The controller 200 is configured to receive among other data, the fuel supply status, aircraft location, and control, among other features, the pumps, motors, sensors, etc.

Further, as can be appreciated, the integrated hydrogen-electric engine system 1 can include any number and/or type of sensors, electrical components, and/or telemetry devices that are operatively coupled to controller 200 for facilitating the control, operation, and/or input/out of the various components of integrated hydrogen-electric engine system 1 for improving efficiencies and/or determining errors and/or failures of the various components.

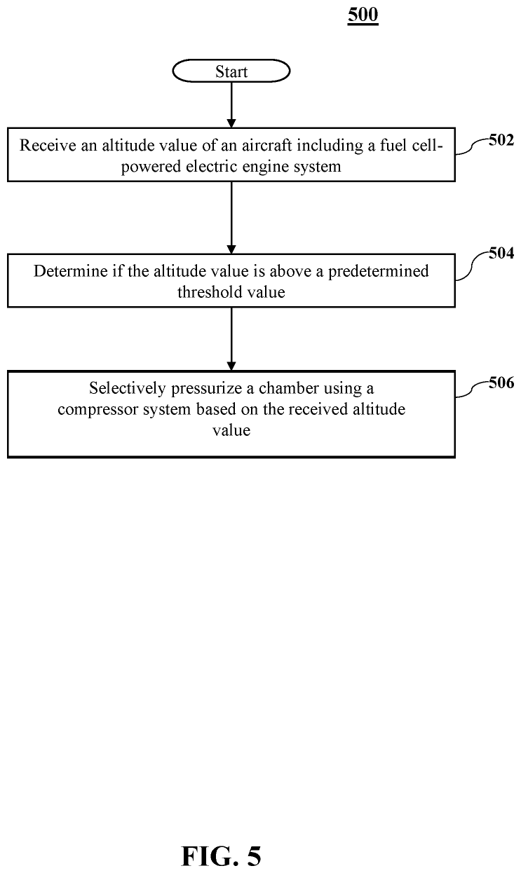

Referring to FIG. 5, there is shown a flow chart of an exemplary computer-implemented method 500 for corona discharge management in accordance with aspects of the present disclosure. Although the steps of FIG. 5 are shown in a particular order, the steps need not all be performed in the specified order, and certain steps can be performed in another order. For simplicity, FIG. 5 will be described below, with the controller 200 performing the operations. However, in various aspects, the operations of FIG. 5 may be performed in part by the controller 200 of FIG. 4 and in part by another device, such as a remote server. These variations are contemplated to be within the scope of the present disclosure.

Initially, the controller 200 receives a current altitude of the aircraft 110. The current altitude may be determined based on sensors, electrical components, and/or telemetry devices that are operatively coupled to the controller 200 (e.g., an altimeter and/or a GPS signal).

Next, controller 200 may determine if the current altitude value is above a predetermined threshold value that may be selected based upon predetermined unpressurized operation parameters of the electrical system, for instance, so that integrated hydrogen-electric engine system 1 can be configured for engine restart at the predetermined threshold value. The predetermined pressurization value may include atmospheric pressure at about sea level, and/or a specific altitude such as up to 10,000 feet above sea level. For example, the compressor system 12 may be configured to keep pressure within the cavity substantially at the value prevailing at sea level. By maintaining pressure at the predetermined pressurization value, corona discharge may be prevented and/or reduced, and the transmission of high voltage signals may be affected at high altitudes without loss of efficiency due to voltage breakdown or leakage.

For example, the current altitude may be about 50,000 feet and the predetermined threshold value may be about 10,000 feet. Therefore, the controller 200 would determine that the current altitude value is above the threshold value of about 10,000 feet.

Next, at step 506, based on the determined current altitude, the controller 200 adjusts the pressure provided by the compressor system 12 to the chamber 11. For example, the controller may adjust pressure (e.g., air pressure) within the chamber 11 using the compressor system 12 (e.g., redirecting/increasing volume and/or flow rate of air flow to the chamber 11. In aspects, any number and/or arrangement of compressors/pumps, valves, geometric changes of fluid conduit(s) that couple compressor system 12 and chamber 11 (e.g., a venturi), and/or any other suitable structure for increasing pressure or flow rate may be provided to pressurize the chamber 11. Indeed, an air pressure equivalent to an air pressure within a range of about sea level (or lower) to about 10,000 feet above sea level can be provided in the chamber 11 when the current altitude goes above the threshold value so that pressure within the chamber 11 stays within the limit of the threshold value. In another example, the controller may determine that current altitude is at or below about 10,000 feet above sea level such that the chamber 11 does not need pressurization (or may be manually or autonomously depressurized such as via a relief valve or the like). The chamber 11 may include a barometer. The controller 200 may receive a signal from the barometer indicating the air pressure of the chamber 11. The controller 200 may further determine if the current altitude reaches or goes below the threshold value and can cause the chamber 11 to be depressurized based on the current altitude. In another aspect, the controller 200 may maintain a pressurization value of the chamber 11 over any altitude. For example, the controller 200 may receive a signal from a barometer in the chamber 11 and adjust the pressurization of the chamber 11 to be one atmosphere (1.01325 bar) or any other suitable amount of pressure.

The integrated hydrogen-electric engine system 1 may include a system for partial power operation and/or restart in case of loss of pressurization. In aspects, the controller 200 may sense a pressure from a sensor (e.g., electronic and/or mechanical) and, based on the sensed pressure, adjust the operating voltage. For example, in the case of a loss of pressurization necessitating a forced descent due to corona discharge, the controller 200 may reconfigure fuel cell stack 26 and/or a battery module (not shown) to produce a lower voltage (e.g., a voltage of about half of full voltage) for powering the motors 30, for example by disconnecting some cells. In aspects, the adjustment of the operating voltage may be based on a control logic. For example, for 990 fuel cells, full voltage may nominally be about 750 volts and after only half or 445 fuel cells remain connected, voltage may be about 375 volts. It is contemplated that any number of appropriate fuel cells may be connected and/or disconnected. The control logic may incorporate a set of control tables that would indicate safe altitude ranges for full and partial voltage operation. For example, the fuel cell 26 or battery modules (not shown) could be wired in series of two or more to produce full voltage under normal circumstances, with one or more modules switched out to reduce operating voltage upon pressurization loss. The disclosed technology provides the benefit of continued flight following a corona discharge event.

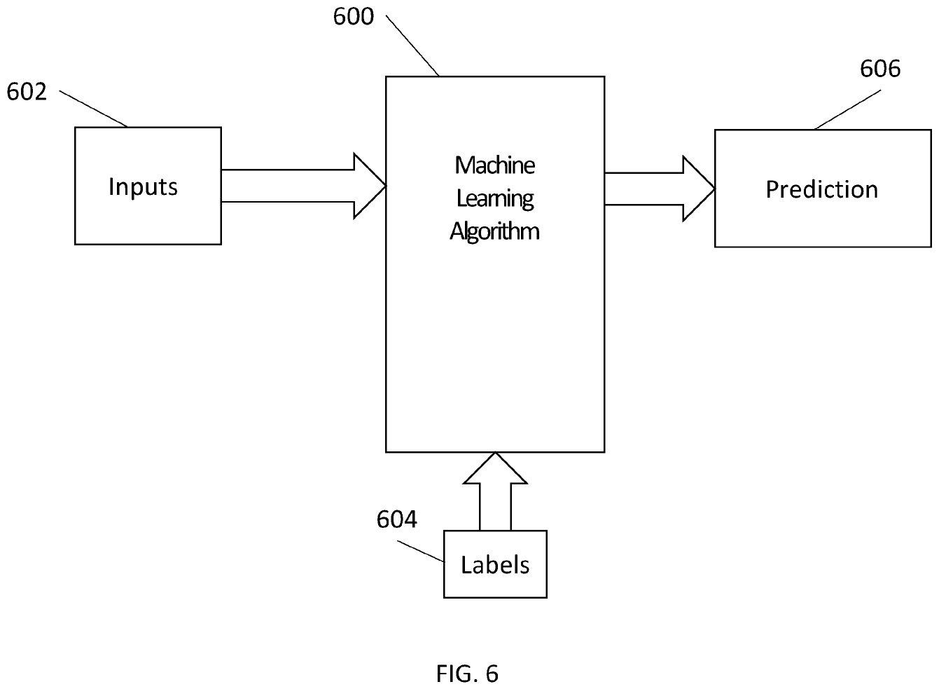

With reference to FIG. 6, the controller 200 may include a machine-learning algorithm 600 configured to make these evaluations. For example, the controller 200 may use machine learning to determine how much to pressurize the chamber 11. For example, machine learning may include a convolutional neural network (CNN) and/or a state variant machine (SVM). The CNN may be trained on previous flight data including altitude and air pressure at that altitude. In aspects, the machine-learning algorithm used would run through the scenario multiple times on its own, and the results may be gathered in addition to feedback and advice from potential experts in the field and then combined to determine which routes on a scenario would wield the greatest results. The machine learning algorithm may be trained using supervised training and/or unsupervised training. The machine-learning algorithm may additionally predict 606 a pressurization value of the chamber based on, for example, a flight profile (e.g., take off, landing, a flight path including different takeoff and landing locations, etc.), the weather, the air traffic, the day of the week/month/year, the volume of the chamber cavity, and/or any other suitable parameter or metric.

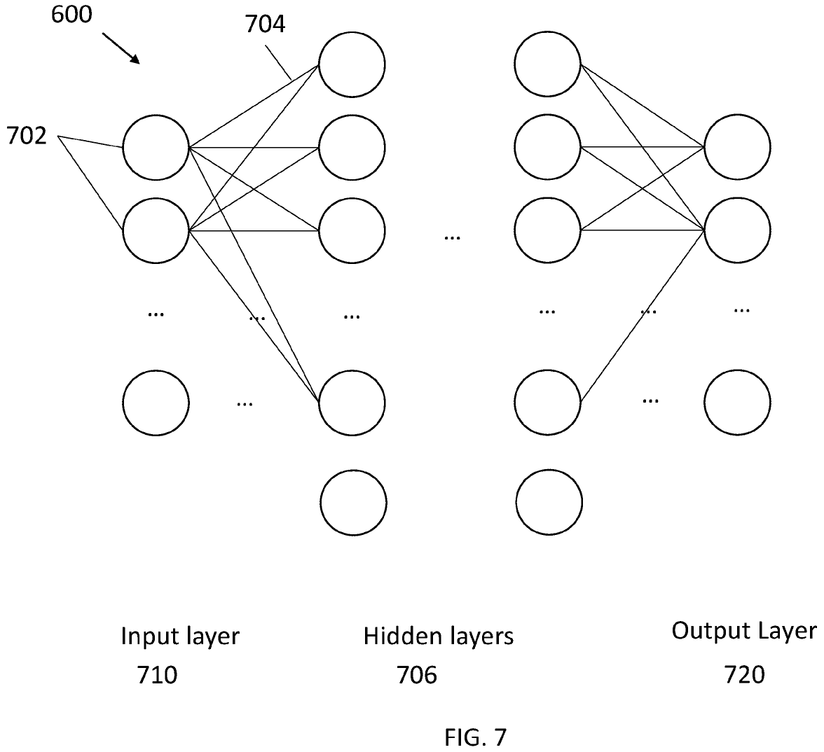

Referring to FIG. 7, generally, the neural network 600 (e.g., a convolutional deep learning neural network) of FIG. 6 includes at least one input layer 710, a plurality of hidden layers 706, and at least one output layer 720. The input layer 710, the plurality of hidden layers 706, and the output layer 720 all include neurons 702 (e.g., nodes). The neurons 702 between the various layers are interconnected via weights 674. Each neuron 702 in the neural network 600 computes an output value by applying a specific function to the input values coming from the previous layer. The function that is applied to the input values is determined by a vector of weights 704 and a bias. Learning, in the deep learning neural network, progresses by making iterative adjustments to these biases and weights. The vector of weights 704 and the bias are called filters (e.g., kernels) and represent particular features of the input (e.g., a particular shape). The neural network 600 may output logits.

It should be understood that the disclosed structure can include any suitable mechanical, electrical, and/or chemical components for operating the disclosed system or components thereof. For instance, such electrical components can include, for example, any suitable electrical, electromechanical, and/or electrochemical circuitry, which may include or be coupled to one or more printed circuit boards. As appreciated, the disclosed computing devices and/or server can include, for example, a “controller,” “processor,” “digital processing device” and like terms, and which are used to indicate a microprocessor or central processing unit (CPU). The CPU is the electronic circuitry within a computer that carries out the instructions of a computer program by performing the basic arithmetic, logical, control and input/output (I/O) operations specified by the instructions and by way of non-limiting examples, include server computers. In some aspects, the controller includes an operating system configured to perform executable instructions. The operating system is, for example, software, including programs and data, which manages hardware of the disclosed apparatus and provides services for execution of applications for use with the disclosed apparatus. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. In some aspects, the operating system is provided by cloud computing.

In some aspects, the term “controller” may be used to indicate a device that controls the transfer of data from a computer or computing device to a peripheral or separate device and vice versa, and/or a mechanical and/or electromechanical device (e.g., a lever, knob, etc.) that mechanically operates and/or actuates a peripheral or separate device.

In aspects, the controller includes a storage and/or memory device. The storage and/or memory device is one or more physical apparatus used to store data or programs on a temporary or permanent basis. In some aspects, the controller includes volatile memory and requires power to maintain stored information. In various aspects, the controller includes non-volatile memory and retains stored information when it is not powered. In some aspects, the non-volatile memory includes flash memory. In certain aspects, the non-volatile memory includes dynamic random-access memory (DRAM). In some aspects, the non-volatile memory includes ferroelectric random-access memory (FRAM). In various aspects, the non-volatile memory includes phase-change random access memory (PRAM). In certain aspects, the controller is a storage device including, by way of non-limiting examples, CD-ROMs, DVDs, flash memory devices, magnetic disk drives, magnetic tapes drives, optical disk drives, and cloud-computing-based storage. In various aspects, the storage and/or memory device is a combination of devices such as those disclosed herein.

In various embodiments, the memory can be random access memory, read-only memory, magnetic disk memory, solid state memory, optical disc memory, and/or another type of memory. In various embodiments, the memory can be separate from the controller and can communicate with the processor through communication buses of a circuit board and/or through communication cables such as serial ATA cables or other types of cables. The memory includes computer-readable instructions that are executable by the processor to operate the controller. In various embodiments, the controller may include a wireless network interface to communicate with other computers or a server. In embodiments, a storage device may be used for storing data. In various embodiments, the processor may be, for example, without limitation, a digital signal processor, a microprocessor, an ASIC, a graphics processing unit (“GPU”), field-programmable gate array (“FPGA”), or a central processing unit (“CPU”).

The memory stores suitable instructions, to be executed by the processor, for receiving the sensed data (e.g., sensed data from GPS, camera, etc. sensors), accessing storage device of the controller, generating a raw image based on the sensed data, comparing the raw image to a calibration data set, identifying an object based on the raw image compared to the calibration data set, transmitting object data to a ground-based post-processing unit, and displaying the object data to a graphic user interface. Although illustrated as part of the disclosed structure, it is also contemplated that a controller may be remote from the disclosed structure (e.g., on a remote server), and accessible by the disclosed structure via a wired or wireless connection. In embodiments where the controller is remote, it is contemplated that the controller may be accessible by, and connected to, multiple structures and/or components of the disclosed system.

The term “application” may include a computer program designed to perform particular functions, tasks, or activities for the benefit of a user. Application may refer to, for example, software running locally or remotely, as a standalone program or in a web browser, or other software which would be understood by one skilled in the art to be an application. An application may run on the disclosed controllers or on a user device, including for example, on a mobile device, an IOT device, or a server system.

In some aspects, the controller includes a display to send visual information to a user. In various aspects, the display is a cathode ray tube (CRT). In various aspects, the display is a liquid crystal display (LCD). In certain aspects, the display is a thin film transistor liquid crystal display (TFT-LCD). In aspects, the display is an organic light emitting diode (OLED) display. In certain aspects, on OLED display is a passive-matrix OLED (PMOLED) or active-matrix OLED (AMOLED) display. In aspects, the display is a plasma display. In certain aspects, the display is a video projector. In various aspects, the display is interactive (e.g., having a touch screen or a sensor such as a camera, a 3D sensor, a LiDAR, a radar, etc.) that can detect user interactions/gestures/responses and the like. In some aspects, the display is a combination of devices such as those disclosed herein.

The controller may include or be coupled to a server and/or a network. As used herein, the term “server” includes “computer server,” “central server,” “main server,” and like terms to indicate a computer or device on a network that manages the disclosed apparatus, components thereof, and/or resources thereof. As used herein, the term “network” can include any network technology including, for instance, a cellular data network, a wired network, a fiber-optic network, a satellite network, and/or an IEEE 802.11a/b/g/n/ac wireless network, among others.

In various aspects, the controller can be coupled to a mesh network. As used herein, a “mesh network” is a network topology in which each node relays data for the network. All mesh nodes cooperate in the distribution of data in the network. It can be applied to both wired and wireless networks. Wireless mesh networks can be considered a type of “Wireless ad hoc” network. Thus, wireless mesh networks are closely related to Mobile ad hoc networks (MANETs). Although MANETs are not restricted to a specific mesh network topology, Wireless ad hoc networks or MANETs can take any form of network topology. Mesh networks can relay messages using either a flooding technique or a routing technique. With routing, the message is propagated along a path by hopping from node to node until it reaches its destination. To ensure that all its paths are available, the network must allow for continuous connections and must reconfigure itself around broken paths, using self-healing algorithms such as Shortest Path Bridging. Self-healing allows a routing-based network to operate when a node breaks down or when a connection becomes unreliable. As a result, the network is typically quite reliable, as there is often more than one path between a source and a destination in the network. This concept can also apply to wired networks and to software interaction. A mesh network whose nodes are all connected to each other is a fully connected network.

In some aspects, the controller may include one or more modules. As used herein, the term “module” and like terms are used to indicate a self-contained hardware component of the central server, which in turn includes software modules. In software, a module is a part of a program. Programs are composed of one or more independently developed modules that are not combined until the program is linked. A single module can contain one or several routines, or sections of programs that perform a particular task.

As used herein, the controller includes software modules for managing various aspects and functions of the disclosed system or components thereof.

The disclosed structure may also utilize one or more controllers to receive various information and transform the received information to generate an output. The controller may include any type of computing device, computational circuit, or any type of processor or processing circuit capable of executing a series of instructions that are stored in memory. The controller may include multiple processors and/or multicore central processing units (CPUs) and may include any type of processor, such as a microprocessor, digital signal processor, microcontroller, programmable logic device (PLD), field programmable gate array (FPGA), or the like. The controller may also include a memory to store data and/or instructions that, when executed by the one or more processors, cause the one or more processors to perform one or more methods and/or algorithms.

Persons skilled in the art will understand that the structures and methods specifically described herein and shown in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, the elements and features shown or described in connection with certain aspects may be combined with the elements and features of certain other aspects without departing from the scope of this disclosure, and that such modifications and variations are also included within the scope of this disclosure. Accordingly, the subject matter of this disclosure is not limited by what has been particularly shown and described.

What is claimed is:

1. An aircraft, comprising:
a chamber supporting at least one of a fuel cell, a motor, or electrical components that electrically communicate with the fuel cell and the motor to power the aircraft;
a compressor system configured to regulate a pressure and a flow of air to the fuel cell, the compressor system in fluid communication with the chamber and configured to selectively pressurize the chamber;
a processor; and
a memory, with instructions stored thereon, which when executed by the processor cause the aircraft to:
receive an altitude value of the aircraft; and
selectively pressurize the chamber using the compressor system based on the received altitude value to reduce corona discharge in the chamber.

2. The aircraft according to claim 1, wherein the altitude value is received by a sensor including at least one of an altimeter, a GPS, or a telemetry device.

3. The aircraft according to claim 1, wherein the instructions, when executed by the processor, further cause the aircraft to:
receive a signal indicating a pressure of the chamber; and
selectively pressurize the chamber using the compressor system based on the signal indicating the pressure of the chamber.

4. The aircraft according to claim 1, wherein the chamber further supports an electrical system of the aircraft.

5. The aircraft according to claim 1, wherein a nacelle of the aircraft includes the chamber.

6. The aircraft according to claim 1, wherein the predetermined threshold value is about 10,000 feet above sea level.

7. The aircraft according to claim 1, wherein the instructions when executed by the processor, cause the aircraft to:
select the predetermined threshold value based upon a predetermined unpressurized operation parameter of the electrical system; and
perform an engine restart of an electrical system at the predetermined threshold value.

8. The aircraft according to claim 1, wherein the instructions, when executed by the processor further cause the aircraft to:
provide as an input to a machine-learning algorithm, the determined altitude value and at least one of a flight profile, weather, or a flight path;
predict a pressurization value by the machine-learning algorithm; and
selectively pressurize the chamber using the compressor system based on the predicted pressurization value to prevent corona discharge in the chamber.

9. The aircraft according to claim 1, further comprising:
a second sensor configured to sense the pressurization value of the chamber,
wherein the instructions, when executed by the processor, cause the aircraft to:
compare the sensed pressurization value to the predetermined threshold value to a predetermined pressurization value;
determine, based on the sensed pressurization value of the chamber, if the altitude value is above the predetermined pressurization value; and
selectively pressurize the chamber using the compressor system based on the predetermined pressurization value to reduce corona discharge in the chamber.

10. A fuel cell-powered electric engine system, comprising:
a chamber configured to house an electrical system of the fuel cell-powered electric engine system, the electrical system including a fuel cell;
a compressor system in fluid communication with the fuel cell and the chamber;
a processor; and
a memory, with instructions stored thereon, which when executed by the processor, cause the system to:
receive an altitude value of the fuel cell-powered electric engine system; and
selectively pressurize the chamber using the compressor system based on the received altitude value to reduce corona discharge in the chamber.

11. The fuel cell-powered electric engine according to claim 10, wherein the altitude value is received by a sensor including at least one of an altimeter, a GPS, or a telemetry device.

12. The fuel cell-powered electric engine according to claim 10, wherein the instructions, when executed by the processor, further cause the system to:
receive a signal indicating a pressure of the chamber; and
selectively pressurize the chamber using the compressor system based on the signal indicating the pressure of the chamber.

13. The fuel cell-powered electric engine according to claim 10, wherein the chamber further supports the electrical system of the fuel cell-powered electric engine.

14. The fuel cell-powered electric engine according to claim 10, wherein a nacelle of an aircraft includes the chamber.

15. The fuel cell-powered electric engine according to claim 10, wherein the predetermined threshold value is about 10,000 feet above sea level.

16. The fuel cell-powered electric engine according to claim 10, wherein the instructions, when executed by the processor, cause the system to:
select the predetermined threshold value based upon a predetermined unpressurized operation parameter of the electrical system; and
perform an engine restart of the integrated hydrogen-electric engine system at the predetermined threshold value.

17. The fuel cell-powered electric engine according to claim 1, wherein the instructions, when executed by the processor, further cause the system to:
provide as an input to a machine-learning algorithm, the determined altitude value and at least one of a flight profile, weather, or a flight path;
predict a pressurization value by the machine-learning algorithm; and
selectively pressurize the chamber using the compressor system based on the predicted pressurization value to reduce corona discharge in the chamber.

18. The fuel cell-powered electric engine according to claim 1, further comprising:
a second sensor configured to sense the pressurization value of the chamber,
wherein the instructions, when executed by the processor, further cause the system to:
compare the sensed pressurization value to the predetermined threshold value;
determine, based on the sensed pressurization value of the chamber, if the altitude value is above a predetermined pressurization value; and
selectively pressurize the chamber using the compressor system based on the predetermined pressurization value to reduce corona discharge in the chamber.

19. A computer-implemented method for corona discharge management, the method comprising:
receiving an altitude value of an aircraft including a fuel cell-powered electric engine system;
and
selectively pressurizing a chamber using a compressor system of the aircraft, based on the received altitude value, to reduce corona discharge in the chamber, wherein the chamber supports at least one of a fuel cell, a motor, or electrical components that electrically communicate with the fuel cell and the motor to power the aircraft.

20. The computer-implemented method according to claim 19, further comprising:
receiving a signal indicating a pressure value of the chamber; and
selectively pressurizing the chamber using the compressor system based on the signal indicating the pressure of the chamber.

21. The computer-implemented method according to claim 19, further comprising:
determining if the altitude value is above a predetermined threshold value; and
selectively pressurizing a chamber using a compressor system of the aircraft, based on the determination.

22. The computer-implemented method according to claim 19, further comprising:
sensing at least one of a pressure, a descent, and/or a corona discharge from a sensor; and
adjusting an operating voltage of a fuel cell stack based on the sensed pressure.
